(19) United States
(12) Patent Application Publication
(10) Pub. No.: US 2008/0087365 A1
(43) Pub. Date: Apr. 17, 2008

(54) Tyre Whose Crown Comprises a Plurality of Zones Formed with a Circumferential Reinforcing Cord

(75) Inventor: Yves Potin, Clermont-Ferrand (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 11/663,764

(22) PCT Filed: Sep. 21, 2005
(86) PCT No.: PCT/EP05/10203

§ 371 Date: May 17, 2007

(30) Foreign Application Priority Data
Sep. 24, 2004 (FR) 04/10219

(51) Int. Cl. B60C 9/18

(52) U.S. Cl. 152/556

(57) ABSTRACT

A tire includes a crown reinforcement provided with a cord forming a plurality of circumferential turns, the cord disposed on opposite sides of a median zone of the tire. The circumferential tension of the cord varies axially along the tire. The circumferential tension of the cord on one side of the median zone diminishes in a direction directed away from one edge of the tire from an edge tension value to an inflection tension value, then increases in that same direction to a median zone tension value greater than the inflection tension value, and then decreases in that same direction back to the inflection tension value at the opposite side of the median zone.

The present invention relates to a tyre comprising a tread with circumferential reinforcements whose tension varies progressively over at least one portion of the width of the crown of the tyre. This type of configuration of the crown reinforcement cords makes it possible to achieve substantial gains with regard to important characteristics of a tyre, such as wear, behaviour on wet ground, noise and comfort in general.

The circumferential reinforcement cords of the crown zone are generally applied directly to a tyre blank, towards the end of the process of assembling the various components. This type of assembly process is widely used in the tyre industry and has numerous advantages, for example in terms of productivity, in particular for products series-produced in large or very large numbers. This type of process generally involves considerable lengths of cable stored in coils or rolls, and ready to be unwound onto the tyre blank during manufacture.

To lay the cord, the latter is guided towards its location and the cord is unwound and applied, while gradually adjusting the axial laying position so as to cover the entire intended crown zone. Such a cord is laid without tension, or with slight pretension, but comprises the same tension over the entire laid width.

According to certain types of embodiment, the nature of the cords varies according to the current axial position. For example, their diameters may vary according to position. It is also possible to use cords of different materials. Finally, certain arrangements are also known in which cords are disposed with a spacing or pitch which varies according to the axial position. Document U.S. Pat. No. 6,766,840 provides such an arrangement, with a larger pitch in the sensitive crown ply edge zones. Document U.S. Pat. No. 5,902,425 also discloses a tyre with a variable pitch, the latter varying so as to become increasingly large towards the centre of the crown. This particular embodiment is intended, however, for tyres for two-wheeled vehicles. Finally, document U.S. Pat. No. 5,032,198 describes a method of laying circumferential reinforcements in which the laying tension varies between the edges and the central region of the crown. The cord is thus laid with an increasingly high tension as it approaches the edges.

Thanks to these various modes of manufacture, it is possible to produce products with advantageous characteristics, and the developers have a broad latitude available to them.

However, certain constraints remain, due on the one hand to the manufacturing process used. For example, a circumferential cord laid without tension is liable to be excessively long after curing. This is because, during moulding, the rubber materials making up the tyre are greatly stressed and thus crushed. They may occupy a smaller volume after moulding than during laying. However, the circumferential cords do not necessarily undergo contraction which would allow this loss of volume to be fully compensated. The result may then be a greater length of cord than is necessary for a tension-free situation, or indeed excess length.

Finally, it is customary for developers who wish to vary the characteristics of the crown reinforcement cords as a function of axial position either to apply additional layers in certain places or to make localised use of different materials or pitches. However, implementing these characteristics may prove expensive, or involve extra weight. On the other hand, these means do not always make it possible to achieve the desired performance for certain types of product for which the technical requirements are high. It would thus be useful for developers wishing to optimise certain architectural characteristics to have other adjusting means at their disposal.

To overcome these various drawbacks, the invention proposes a tyre comprising at least one carcass-type reinforcement structure anchored on each side of said tyre in a bead whose base is intended to be fitted on a rim seat, each of said beads being extended substantially radially on the outside in the form of sidewalls, the sidewalls meeting up radially towards the outside with a tread, the carcass-type reinforcement structure extending circumferentially from the bead towards said sidewall, a crown reinforcement, each of the beads additionally comprising an anchoring zone allowing the reinforcement structure to be held in place, said crown reinforcement comprising a cord disposed circumferentially so as to form a plurality of turns in which the circumferential tension is capable of varying as a function of the axial position of the cord so as to form at least two lateral tension variation zones in which the tension varies inversely, from an edge tension value Tb with a tension value diminishing axially towards the centre until a first inflection point I is reached in which the value of the tension corresponds to the inflection tension Tinf, the lateral zones being separated by at least one median zone in which, starting from said first inflection point and taking an axially central direction, the tension increases up to a median zone tension value Tmed, greater than that of the inflection tension Tinf, then diminishes down to the inflection tension Tinf on the other side of the median section of the crown, at the level of the second inflection point I, situated on the other side of the median section of the crown.

Such a tyre has behaviour and endurance qualities superior to those of a reinforced crown tyre of known type. Furthermore, an increase is noted in the surface area of the contact area on the sides of the tyre, which enhances tyre behaviour.

This type of tyre may be produced for example by means of substantially continuous management or control of the laying tension of the circumferential cord.

Furthermore, by laying the circumferential cord with a certain degree of pretension, it is possible to avoid the situation in which such a cord displays excess length after curing of the tyre.

According to one advantageous embodiment, the median zone is disposed in substantially axially central arrangement.

According to another advantageous embodiment, circumferential tension varies substantially symmetrically on each side of the median section of the tyre.

According to still another advantageous embodiment, the tension Tint of the intermediate zone is substantially constant over a plurality of turns (at least four turns, and according to one advantageous example over a crown width of approximately 45 mm).

According to an advantageous example of embodiment of the invention, the tension Tmed is less than the tension Tb.

According to another advantageous example of embodiment of the invention, the tension Tmed is greater than the tension Tb.

The intermediate zone advantageously comprises a central portion consisting of a plurality of turns in which the tension has a central portion tension value Tpc different from (greater or less than) the median tension Tmed. According to one example of embodiment, the Tpc value is substantially zero.

Advantageously, the circumferential tension of the tension variation zones varies in substantially linear manner over at least one portion of one zone.

According to various embodiments of the invention, the laying pitch is substantially the same in a given zone, and/or it is not identical in all the zones.

Advantageously, the tyre according to the invention comprises a single circumferential cord to which the tension variation profile is applied. This imparts advantages with regard to laying time, fitting and adjustment, these being optimised in comparison with laying of a plurality of cords disposed side by side. The tension profile is furthermore better controlled.

In the present description, the term “cord” denotes wholly generally both monofilaments and multifilaments, or assemblies such as cables, plied yarns or indeed any equivalent type of assembly, whatever the material of these cords and whatever the treatment they have undergone. The treatment may for example comprise surface treatments, coating or pre-sizing treatment to improve adhesion to the rubber. The expression “unitary cord” denotes a cord composed of a single element, unassembled. The term “multifilaments” denotes on the other hand an assembly of at least two unitary elements to form a cable, a plied yarn, etc.

“Circumferential cords” are understood to be cords disposed at substantially zero degrees relative to the direction of rotation of the tyre.

The “characteristics of the cord” are understood to mean, for example, its dimensions, its composition, its mechanical characteristics and properties (in particular the modulus), its chemical characteristics and properties etc.

As a reminder, “radially towards the top” or “radially upper” or “radially towards the outside” means towards the larger radii.

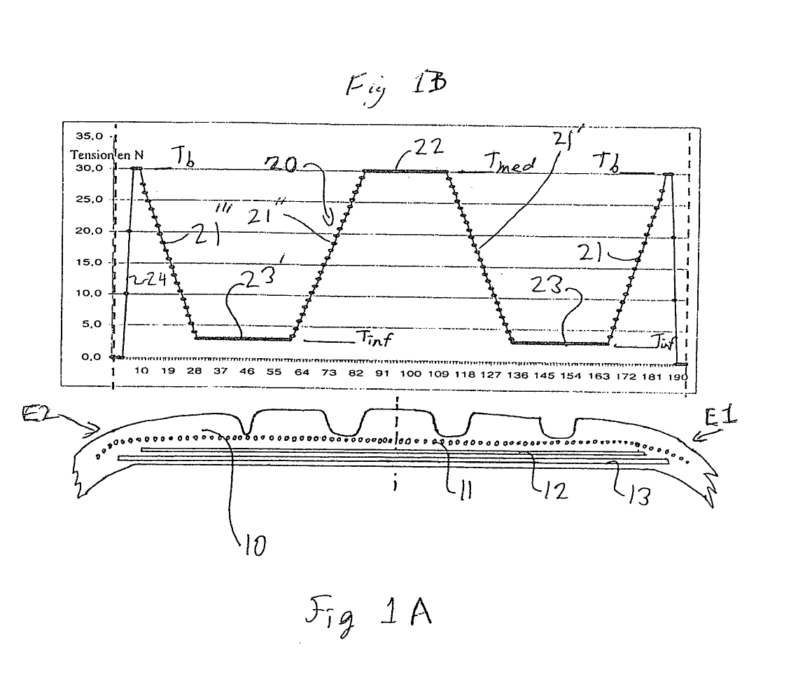

All practical details are given in the following description, supplemented by FIGS. 1 to 7, in which:

FIG. 1 shows a profile of a section through a crown of a tyre in which the circumferential cords are visible, this section being aligned with a graph illustrating a laying tension profile for a circumferential cord;

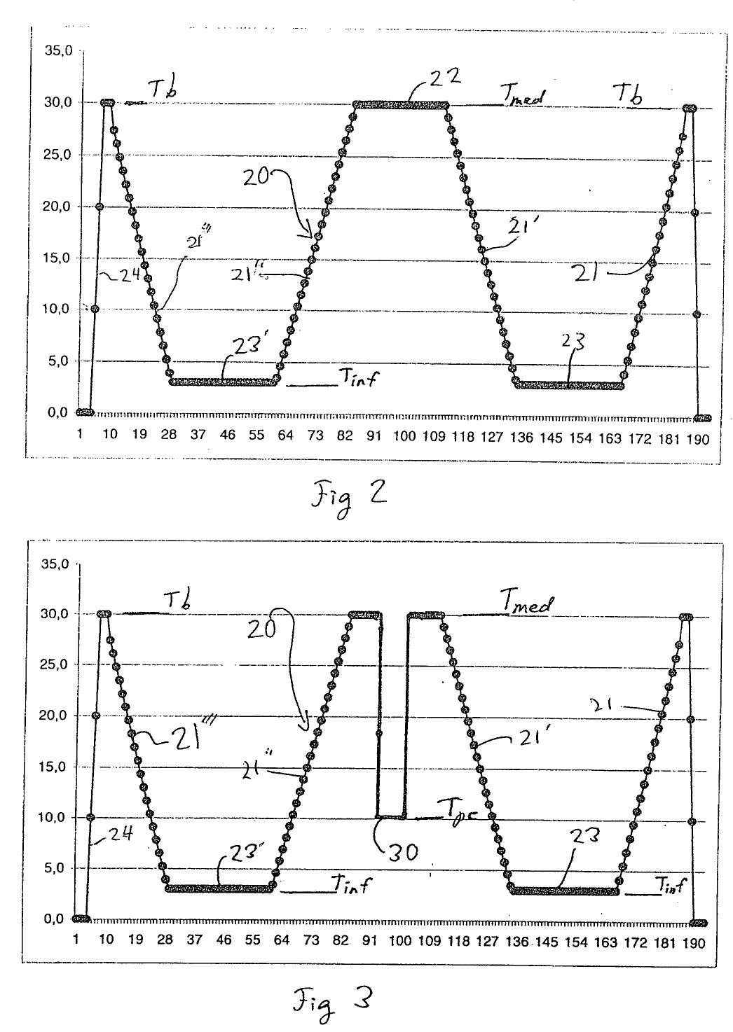

FIG. 2 shows the laying tension profile of the example of FIG. 1;

FIG. 3 shows a variant of the laying tension profile of the example of FIG. 1 comprising a central portion with a tension whose value is less than that of the median zone;

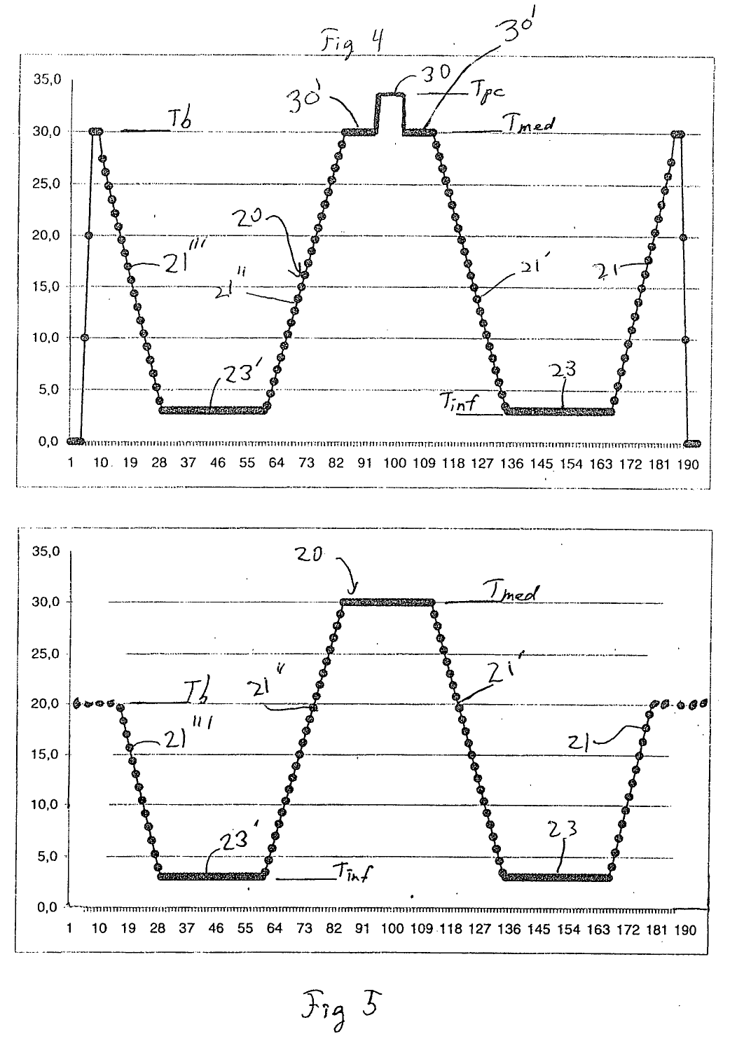

FIG. 4 shows another variant of the laying tension profile of the example of FIG. 1 comprising a central portion with a tension whose value is substantially zero;

FIG. 5 shows another variant of the laying tension profile of the example of FIG. 1 comprising a central portion with a tension whose value is greater than that of the median zone;

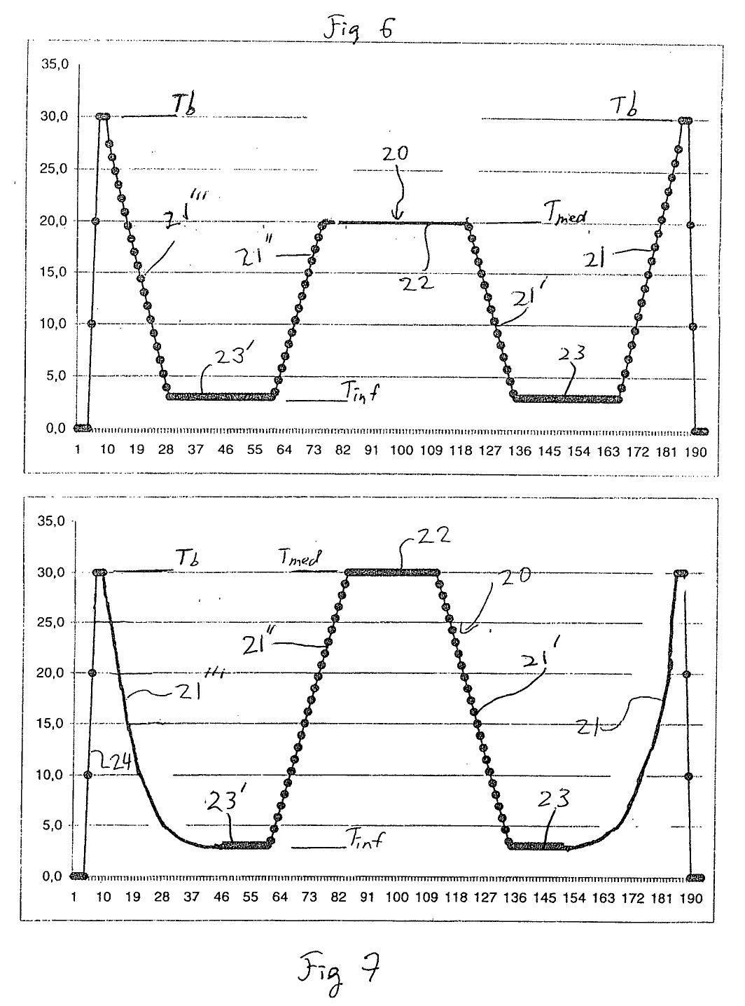

FIG. 6 shows a variant of the laying tension profile of the example of FIG. 1 comprising a central portion with a tension whose value is less than both that of the median zone and that of the edges;

FIG. 7 shows a variant of the laying tension profile of the example of FIG. 1, in which the lateral tension variation zones are not linear.

FIG. 1 illustrates an example of axial distribution of the circumferential cords at the level of the crown of a tyre. The bottom portion of the Figure shows an example of embodiment of a crown zone of a tyre, with two layers of crown reinforcements, i.e. a radially outer crown reinforcement layer 12 and a radially inner crown reinforcement layer 13 and a series of circumferential reinforcements 11 disposed radially to the outside of these two layers 12 and 13. The graph situated above this tyre portion shows an example of the value or profile of the laying tension 20 of the cord as a function of its axial position along the crown. In greater detail, the x-axis plots the axial position of the cord and the y-axis an example of tension applied during laying, in newtons. The axial position is given by numbering each of the turns made by the cord, from the first turn, to the left in the Figure, to the 190^{th} turn, to the right in the Figure. In this example, the total number of turns is 190. In other examples of embodiment, this total number of turns, like the laying pitch, may vary almost infinitely, without departing from the scope of the present invention.

According to this example, the first turns are laid at a substantially elevated edge tension Tb, in this example around 30 N. Then, in a lateral tension variation zone 21, the laying tension diminishes gradually, until an inflection zone 23 is reached, in which the tension has an inflection value Ti, lower than Tb, i.e. approximately 4 N in this example. The laying tension value then increases gradually again towards the median portion or zone 22 of the tyre. In this example, the tension varies in substantially linear manner. At around the 73^{rd} turn, the median zone 20 is reached, and the cords are laid over several turns with substantially the same laying tension. In this example, approximately 40 turns constitute the median portion. The tension level of this zone is around 30 newtons.

Continuing to study this same Figure, it will be noted that, to the right of the median zone, the laying tension of the circumferential cord diminishes, from the median tension value, i.e. approximately 30 N, towards an ever lower value, in a substantially linear decline, down to a second, inflection tension value Ti, at which the tension is substantially stable over several turns. The value of the laying tension finally rises from the value Ti to a value Tb, for the windings situated in the vicinity of the edge of the crown.

The laying tension profile of the cord thus forms a sort of “W”. In this example, the tension profile is substantially symmetrical relative to the central section of the tyre. A U-shaped tension profile is thus obtained on each side of the central section of the tyre.

In this example of embodiment, the value of the tension Ti is substantially constant over approximately 30 turns.

According to various variants, one or more parameters may vary, such as: laying pitch, the rate of variation of the tension, the relative width of the various portions, namely the lateral tension variation zones and the median zone, the maximum and minimum tension values, etc. The developers thus have available to them a very flexible design tool, which can be adapted to numerous types of products and allows optimisation of various parameters of the product.

FIG. 2 shows the tension profile of a circumferential cord for the example of embodiment of FIG. 1. FIGS. 3 to 5 show variants of this example, in which the median zone comprises a central portion 30, several turns in width, in which the laying tension Tpc is substantially different from the tension value of the median zone. For example, in FIG. 3, the Tpc value is substantially less than the Tm value (approximately 10 N), but greater than zero N. Of course, Tpc may also have a value of substantially zero. In FIG. 4, Tpc is substantially greater than Tm (approximately 35 N as compared to 30 N).

In the example of embodiment of FIG. 5, the Tmed value is greater than Tb, the edge tension. This is because, in this example, the crown edges comprise portions in which the laying tension is substantially constant, in this example around 20 N, over a width of several turns.

In the example of embodiment of FIG. 6, the Tmed value is less than Tb, the edge tension. This is because, in this example, the median zone 22 comprises a Tmed tension value of around 20 N, thus less than the Tb value, which is around 30 N.

The embodiment of FIG. 7 differs in that the rate of variation in tension of at least one of the lateral zones 21, between the edges and the median zone 22, is not linear. In the example illustrated, it forms a concave profile. According to one variant, this profile results in a convex shape. Finally, various combination variants are possible, with concave and convex portions on one and the same side of the median portion, or alternatively one side concave and the other convex.

In the example illustrated in FIG. 1, a crown reinforcement consists of for example two layers of reinforcement cords 12 and 13 disposed according to substantially equal but inverse angles. Of course, other types of arrangement may be used without departing from the scope of the present invention. Thus, the number of layers, the angles used and the types of cord may differ.

Industrial manufacture of a tyre according to the invention may be achieved using several types of process. It is advantageous to apply the principle of laying on a central core, so allowing individual laying of the constituent elements such as the rubber mixes and the reinforcements (cords) or alternatively the laying of semi-finished products such as reinforced rubber strips.

1-9. (canceled)

10. A tire comprising a crown having first and second crown edges; first and second beads adapted to be fitted on a rim seat; and at least one carcass-type reinforcement structure anchored in the first and second beads, each of said beads being extended substantially radially on the outside in the form of sidewalls, the sidewalls meeting up radially towards the outside with a tread; the carcass-type reinforcement structure extending circumferentially from the bead towards said sidewall; each of the beads comprising an anchoring zone in which the carcass-type reinforcement structure is held in place; the crown including a crown reinforcement comprising a circumferential cord arrangement forming a plurality of turns whose circumferential tension varies axially along the tire; wherein the cord arrangement, beginning on a first side of a median zone of the tire between the median zone and the first crown edge, diminishes in a direction toward the second crown edge, from an edge tension value to an inflection tension value, and thereafter increases in said direction on said first side of the median zone, from the inflection tension value to a median zone tension value which is greater than the inflection tension value, and thereafter decreases in said direction back to said inflection tension value on a second side of the median zone opposite the first side.

11. A tire according to claim 10, in which the median zone is disposed at an axial center of the tire.

12. A tire according to claim 11, in which the circumferential tension varies substantially symmetrically with respect to the median zone.

13. A tire according to claim 12, in which the median zone is formed by a plurality of cord turns having a substantially constant tension value.

14. A tire according to claim 13, in which the median tension value is less than the edge tension value.

15. A tire according to claim 13, in which the median tension value is greater than the edge tension value.

16. A tire according to claim 12, in which the median zone includes center cord turns and end cord turns disposed at opposite ends of the center cord turns, wherein the median zone tension value is defined by the end cord turns, and wherein the center cord turns define a circumferential tension value different from the median zone tension value.

17. A tire according to claim 12 wherein the portion of the cord arrangement in which the circumferential tension diminishes from the edge tension value to the inflection tension value defines a first tension variation zone; the portion of the cord arrangement in which the circumferential tension increases to the median zone tension value on the first side of the median zone defines a second tension variation zone; the portion of the cord arrangement in which the circumferential tension diminishes back to the inflection tension value on said second side of the median zone defines a third tension variation zone; wherein the circumferential tension varies in a substantially linear manner over at least one part of one of said first, second and third tension variation zones.

18. A tire according to claim 12 wherein the cord arrangement consists of a single helically wound cord.

19. A tire according to claim 10, in which the circumferential tension varies substantially symmetrically with respect to the median zone.

20. A tire according to claim 10, in which the median zone is formed by a plurality of cord turns having a substantially constant tension value.

21. A tire according to claim 20, in which the median tension value is less than the edge tension value.

22. A tire according to claim 20, in which the median tension value is greater than the edge tension value.

23. A tire according to claim 10 wherein the portion of the cord arrangement in which the circumferential tension diminishes from the edge tension value to the inflection tension value on the first side of the median zone defines a first tension variation zone; the portion of the cord arrangement in which the circumferential tension increases to the median zone tension value defines a second tension variation zone; the portion of the cord arrangement in which the circumferential tension diminishes back to the inflection tension value at said opposite side of the median zone defines a third tension variation zone; wherein the circumferential tension varies in a substantially linear manner over at least one part of one of said first, second and third tension variation zones.

24. A tire according to claim 23 wherein the cord arrangement defines a fourth tension variation zone between the third tension zone and the second crown edge, in which the circumferential tension increases to the edge tension value.

25. A tire according to claim 10 wherein the cord arrangement consists of a single cord.

26. A tire comprising a crown having first and second crown edges; first and second beads adapted to be fitted on a rim seat; and at least one carcass-type reinforcement structure anchored in the first and second beads; each of said beads being extended substantially radially on the outside in the form of sidewalls, the sidewalls meeting up radially towards the outside with a tread; the carcass-type reinforcement structure extending circumferentially from the bead towards said sidewall; each of the beads comprising an anchoring zone in which the carcass-type reinforcement structure is held in place; the crown including a crown reinforcement comprising a circumferential cord arrangement forming a plurality of turns whose circumferential tension varies axially along the tire; wherein the cord arrangement includes:
a first tension zone situated axially between the first crown edge and a median zone of the tire, in which first zone the circumferential tension of the cord arrangement gradually diminishes, in a direction toward the second crown edge, from an edge tension value to an inflection tension value,
a second tension zone situated axially between the first tension zone and the median zone, in which the circumferential tension of the cord arrangement gradually increases in said direction, from said inflection tension value to a median zone tension value which is greater than said inflection tension value, and
a third tension zone situated axially between the median zone and the second crown edge, in which the circumferential tension of the cord arrangement gradually decreases in said direction, from said median zone tension value to said inflection tension value.

27. The tire according to claim 26, wherein the cord arrangement includes a fourth tension zone situated axially between the third tension zone and the second crown edge, in which the circumferential tension of the cord arrangement gradually increases in said direction, from the inflection tension value to the edge tension value.
